(19) United States
(12) Patent Application Publication
(10) Pub. No.: US 2016/0027271 A1
(43) Pub. Date: Jan. 28, 2016

(54) Security Tag

(71) Applicant: Aprium Tech Limited, London (GB)

(72) Inventors: Kannan Michael Paul, London (GB); David Lee Sandbach, Brighton (GB); Robin Souter, London (GB); Peter Samuel Veash, London (GB)

(21) Appl. No.: 14/803,172

(22) Filed: Jul. 20, 2015

(30) Foreign Application Priority Data
Jul. 23, 2014 (GB) 14 13 101.5
Dec. 12, 2014 (GB) 14 22 278.0

(51) Int. Cl. G08B 13/24

(52) U.S. Cl. CPC G08B 13/2454; G08B 13/2434

(57) ABSTRACT

A security tag is shown for location upon an article and removal from the article upon receiving authorisation. An internal processor (303) is arranged to transmit an output signal to an external processor indicating that a customer has identified an interest in an article. A physical switch (103) is operated to initiate a procedure for purchasing the article and releasing the tag. The tag transmits an output signal to initiate a release procedure and then receives an input signal to effect a release. The output signal is received by a mobile device and the mobile device interacts with an administration system directly to effect the purchase of the item prior to the administration system issuing the input signal. After receiving the input signal, actual release is only achieved after a further manual operation being performed by the user.

### CROSS REFERENCE TO RELATED APPLICATIONS

This application claims priority from United Kingdom Patent Applications 1413101.5 filed 23 Jul. 2014 and 1422278.0 filed 12 Dec. 2014, the entire disclosures of which are incorporated herein by reference in their entirety.

### BACKGROUND OF THE INVENTION

1. Field of the Invention

The present invention relates to a security tag for location upon an article and removal from said article upon authorisation.

2. Description of the Related Art

It is known to attach security tags to articles of merchandise which are then released when the merchandise is purchased by a customer. The tags may include a locking mechanism with a releasing device for attaching the tag to the article. In addition, it is known to provide a release signal detection circuit with an electro-mechanical actuator that releases the locking mechanism when the release signal detection circuit receives a release signal.

Although operatives may be trained to effect the required release procedure, the requirement for procedures of this type do not facilitate the releasing of tags by customers themselves when they have successfully purchased an article. Furthermore, in many known systems, the continual monitoring of the presence of an external signal consumes significant electrical power, therefore measures must be adopted to maintain the availability of electrical power so that the tag remains active during an operational period.

### BRIEF SUMMARY OF THE INVENTION

According to a first aspect of the present invention, there is provided a security tag for location upon an article and removal from said article upon authorisation, comprising: an internal processor arranged to transmit an output signal to an external processor indicating that a customer has identified an interest in the article; and physical switching means, wherein an activation of said physical switching means initiates a procedure for said internal processor to transmit said output signal.

In a preferred embodiment, the security tag has a housing, wherein the physical switching means is a manually operable switch extending from said housing.

According to a second aspect of the present invention, there is provided a security tag for location upon an article and removal from said article upon authorisation, comprising: a transmitter for transmitting an output signal to a mobile device; and a receiver for receiving an input signal from an administration system indicating that the tag can be released, wherein: said mobile device interacts with said administration system directly to effect a purchase of the item prior to the administration system issuing said input signal.

In a preferred embodiment, the transmitter is activated after the tag has experienced an interaction with the user.

According to a third aspect of the present invention, there is provided a security tag for location upon an article and removal from said article upon authorisation, comprising: an internal processor; and a release mechanism, wherein: said internal processor is arranged to receive an input signal indicating an authorisation to remove; and said internal processor is configured to facilitate a removal upon receiving said input signal and upon detecting a manual operation performed by the user.

### BRIEF DESCRIPTION OF THE DRAWINGS

FIG. 1 shows a security tag attached to an article;

FIG. 2 illustrates an interaction with a mobile device;

FIG. 3 details a primary portion of a security tag;

FIG. 4 shows the primary portion of the security tag identified in

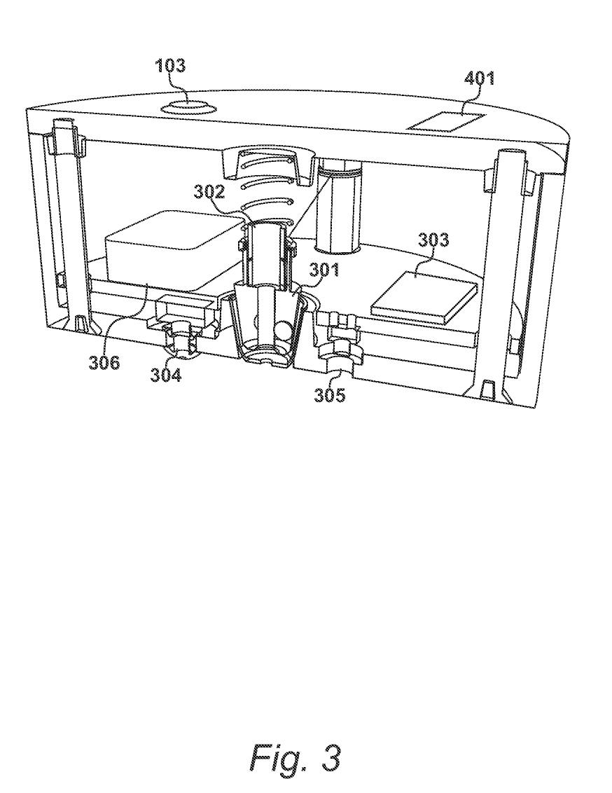

FIG. 3 in cross-section, cooperating with a secondary portion of a security tag;

FIG. 5 shows a diagrammatic representation of the primary portion identified in FIG. 3 and including an internal processor;

FIG. 6 details operations performed by the internal processor identified in FIG. 5;

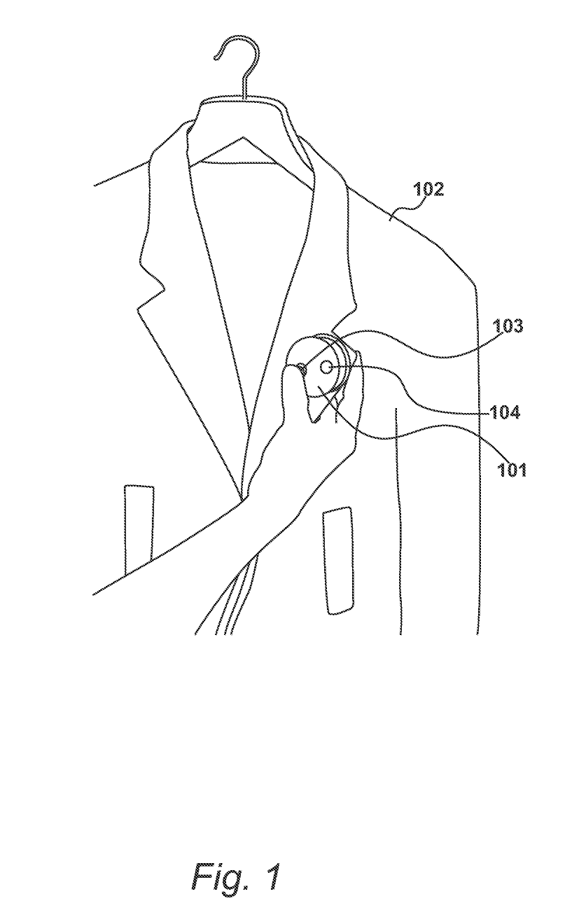

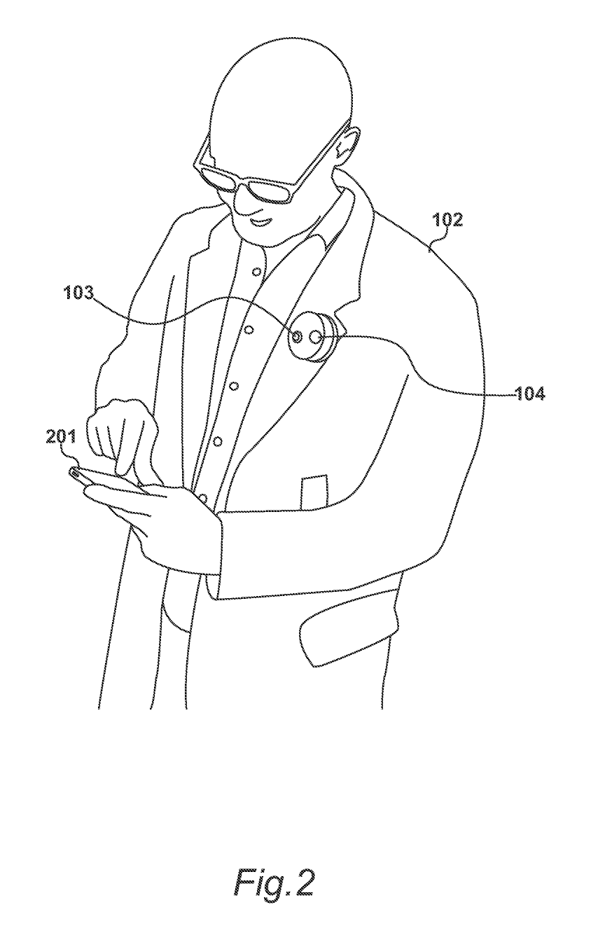

FIG. 7 shows a protocol diagram representing communications performed within the environment illustrated in FIG. 1; and

FIG. 8 shows the collection of disengaged tags.

### DETAILED DESCRIPTION OF EXAMPLE EMBODIMENTS

### FIG. 1

A security tag 101 is shown in FIG. 1, attached to an article 102. The security tag 101 can be removed from the article 102 upon receiving an authorisation. The tag includes an internal processor arranged to transmit an output signal to an external processor indicating that a customer has identified an interest in the article. The security tag 101 is provided with physical switching means 103, wherein an activation of the physical switching means 103 initiates a procedure for the internal processor to transmit the output signal.

In the embodiment of FIG. 1, the security tag has a housing and the physical switching means 103 is a manually operable switch extending from this housing.

In an embodiment, the internal processor remains in a minimal power consumption state when not required to interact. Procedures are initiated, possibly by operation of button 103, by interrupting the internal processor out of this minimal power consumption state.

In the embodiment of FIG. 1, there is also provided a visual indicator 104, that could be in the form of an LED or in the form of a passive indicator that experiences a change of state. The visual indicator 104 is activated in response to an initiation of the procedure; that is to say, in response to the operation of button 103 in this embodiment.

As described herein, a procedure is performed in order to obtain an authorisation, possibly after a user has purchased the article to which the tag has been attached. In an embodiment, the visual indicator 104 (or an alternative indicator) or a display elsewhere in the store, is activated again so as to invite further manual operation. Thus, in an embodiment, after authorisation, the tag is removed but only after further manual operation, possibly in the form of a further manual operation of button 104.

Thus, in an embodiment, a user activates switching means 103 in order to identify their interest in the article. Illumination device 104 is illuminated, indicating that the tag has become aware of the user's interest and as such it transmits an output signal to an external processor. This initiates a procedure during which the customer-user can complete the transaction. Confirmation to the effect that the transaction has been completed is provided by the tag 101 activating illumination device 104 again. Thus, upon this second illumination (or illumination in an alternative form), the user can remove the tag. For example, when implemented as an LED, different colours could be selected for the first and second illuminations, such as a red illumination followed by a green illumination.

In this embodiment, this tag removal is only achieved after the user has activated the physical switching means again. In this way, the user has control over the removal of the tag to assist with the disposal of the tag in an appropriate receiving receptacle.

In the embodiment shown, the physical switching means extends from the housing. However, it should be appreciated that in alternative embodiments the switching means could be contained within the housing. In the embodiment, the physical switching means takes the form of a manually operable switch. However, as an alternative, and when enclosed within the housing, the physical switching means could take another form activated by physical movement of the security tag. Thus, for example, use could be made of accelerometers, either specifically added to the circuitry of the tag or already present within a selected internal processor. Similarly, other devices such as peizo-electric devices could be deployed in order to provide the physical switching means.

### FIG. 2

In a retail shopping environment, a customer may be encouraged to try on an article 102 without assistance possibly in a changing room environment. Furthermore, it is possible for the customer to complete the financial transaction without assistance.

In Accordance with an aspect of the present invention, the release procedure involves a communication with a mobile device 201, such as a mobile cellular telephone. Thus, the security tag is provided for location upon an article and removal from the article upon authorisation. A transmitter transmits an output signal to a mobile device 201. Furthermore, the tag includes a receiver for receiving an input signal from an administration system indicating that the tag can be released. From a user's perspective, it appears as if communication continues between their mobile device 201 and the tag 101 in order to achieve a release of the tag. However, in accordance with this aspect of the present invention, the mobile device interacts with the administration system directly to effect a purchase of the item prior to the administration system issuing the input signal.

As previously described, the transmitter is activated after the tag has experienced an interaction with the user, such as, but not exclusively, the user activating button 104. This results in a first visual indication being presented to the user immediately before or immediately after the tag transmits the output signal. Furthermore, in an embodiment, the output signal represents a unique tag identification. Thus, when the output signal is transmitted to the mobile device, in an embodiment, this results in the mobile device receiving the unique tag identification. Furthermore, in an embodiment, the interaction further includes the sending of the unique tag identification and a mobile identification to the administration system from the mobile device.

Thus, according to this aspect of the invention, further communication now occurs directly between the mobile device and the administration system; not the tag. If the transaction is successful, the tag then receives the input signal. In an embodiment, a second visual indication is provided when the input signal has been received, possibly by activating visual display device 104. Thereafter, in an embodiment, the tag is released only after experiencing a further physical action performed by the user; possibly the operation of button 103.

### FIG. 3

A primary portion of a security tag for attachment to an article is shown in FIG. 3. The primary portion includes a locking mechanism 301 for locking a locking part of a secondary portion of the security tag, so as to secure the security tag to an article.

In an embodiment, a releasing mechanism 302 releases the locking mechanism 301, so as to release a locking part of the secondary portion.

An internal processor 303 is configured to activate the releasing mechanism 302 in response to receiving an input signal. As previously described, the physical switching means 103 is configured to instruct the internal processor 303 to initiate a release procedure.

In the embodiment of FIG. 3, the locking mechanism is arranged to hold the locking parts securely in place, such that it is not possible to physically separate the primary portion from the secondary portion of the tag. In this embodiment, the housing of the secondary portion is shaped so as to make it difficult to mechanically grip this portion. Furthermore, the locking part may take the form of a pin that itself may rotate in its housing, such that rotation does not result in a relative movement between the pin and a clutch of the locking mechanism 301.

In the embodiment of FIG. 3, there is provided a first detection device 304 and a second detection device 305, each configured to activate if the primary portion is removed from being in contact with the article. In this way, it is not necessary to achieve a secure attachment of the primary portion to the secondary portion.

In an alternative embodiment, a mechanism may be provided for holding the primary portion in contact with the article but this mechanism would not prevent manual removal. However, the detection device will then activate, so as to generate a local alarm signal and so as to notify the administration system, if the tag is removed.

In an embodiment, the first detection device 304 is in the form of a mechanical switch that remains closed when the primary portion is in contact the article but will open when the primary portion is removed from the article. In an embodiment, the second detection device 305 is an optical device. Thus, optical device 305 does not receive light when the primary portion is against the article 102 but will receive ambient light when the primary portion is removed; thus activating the alarm. In an embodiment, the local alarm may be an audible alarm device, possible taking the form of a peizo-electric device.

In an alternative embodiment, the detection device includes a lever configured to extend from the primary portion when the primary portion is removed from the article.

In an embodiment, the primary portion includes a socket for receiving electrical charge. Charge is supplied to a power supply unit 306.

In an embodiment, before receiving a command to initiate the release procedure, the internal processor is in a minimal power consumption (sleep) state. Thus, the power supply unit 306 may contain sufficient charge to maintain the internal processor in this sleep state for several months without requiring an additional charge.

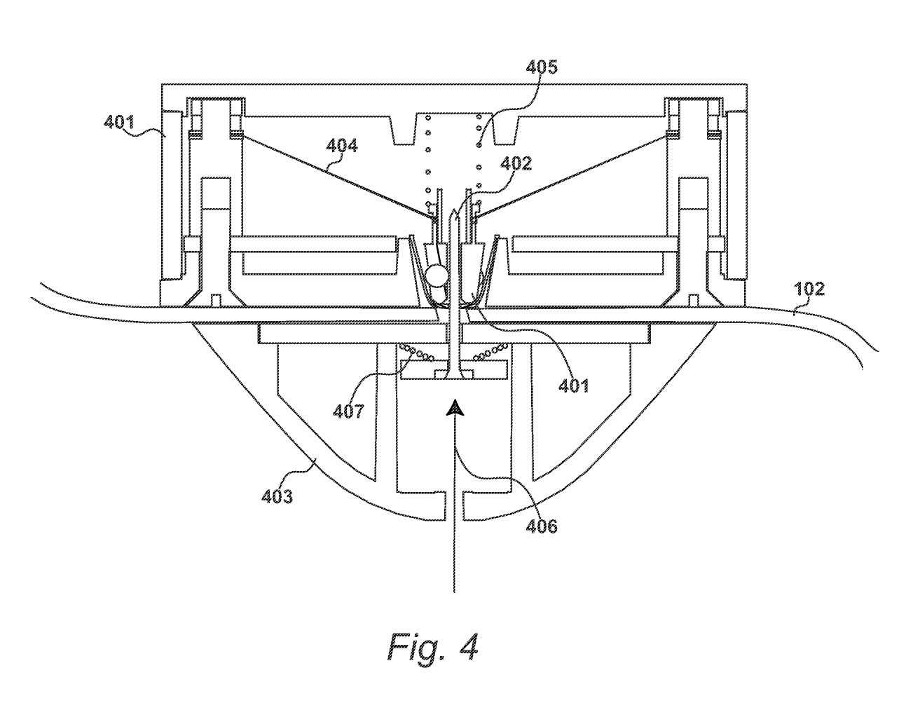

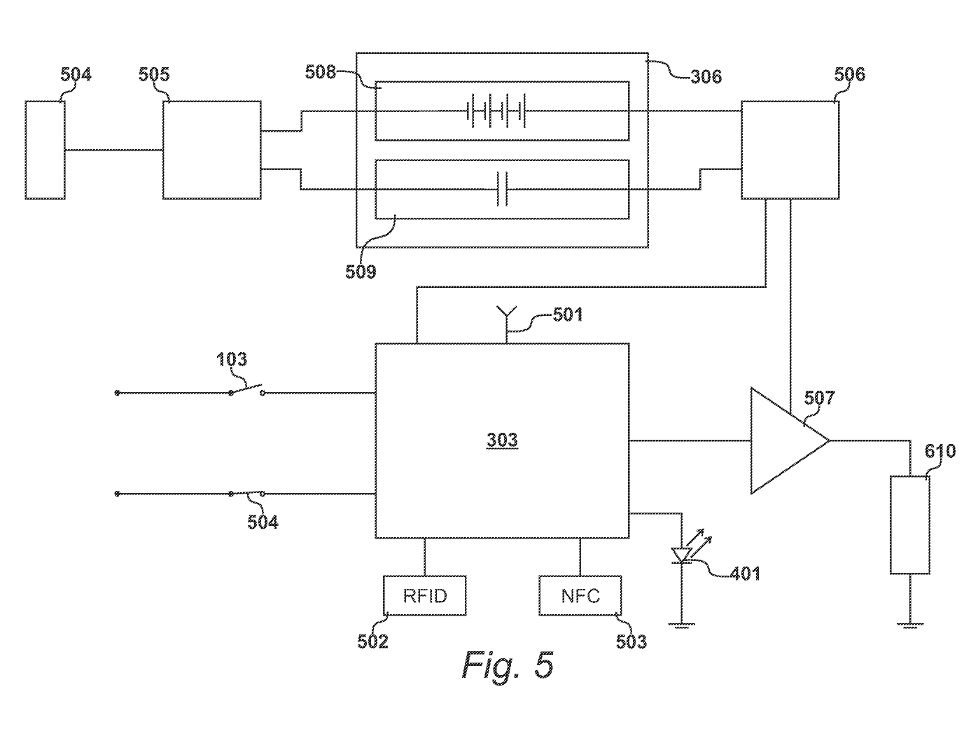

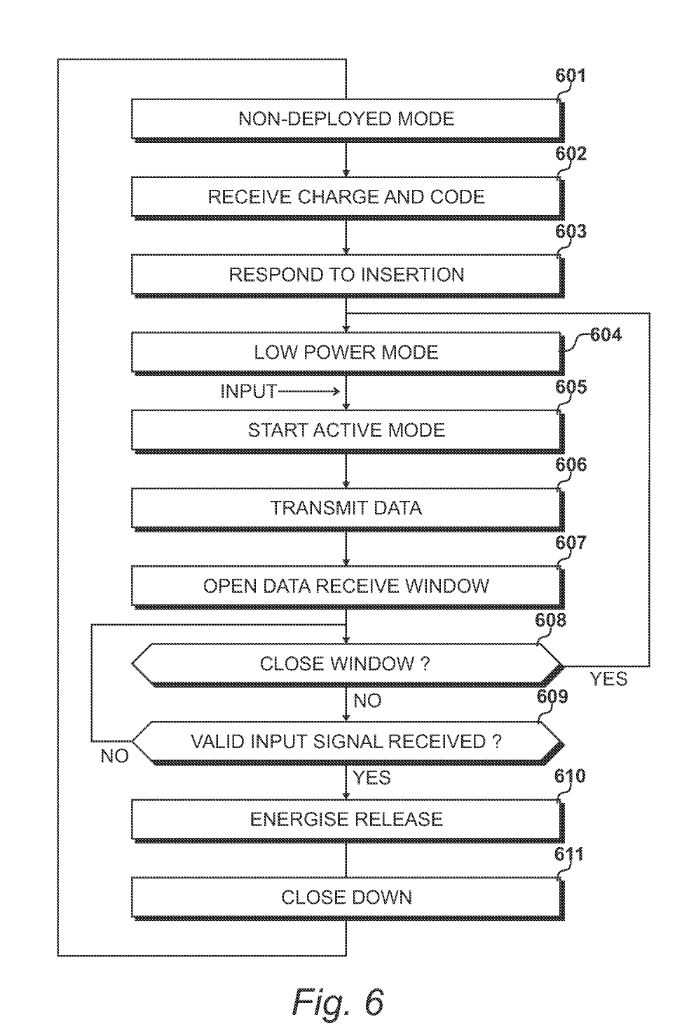

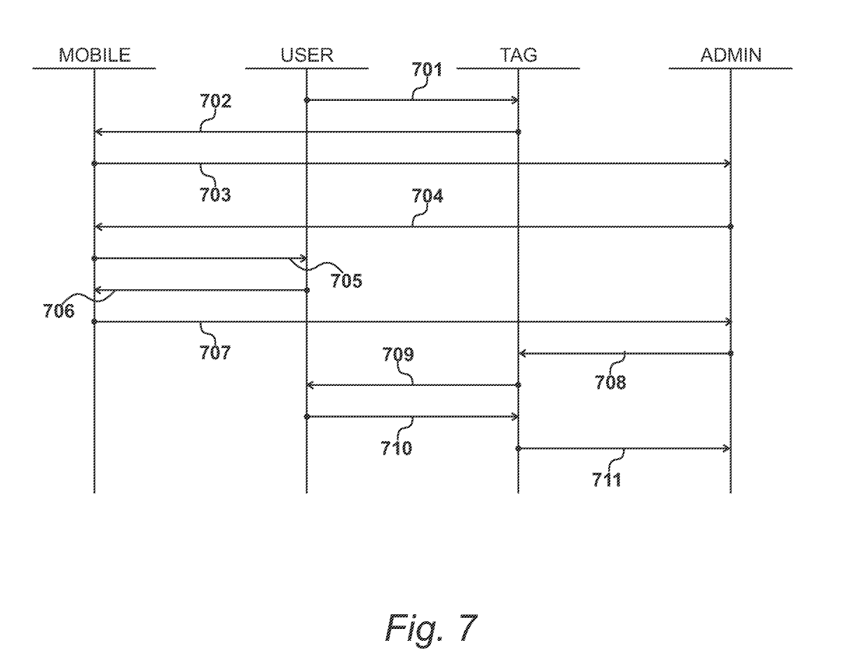

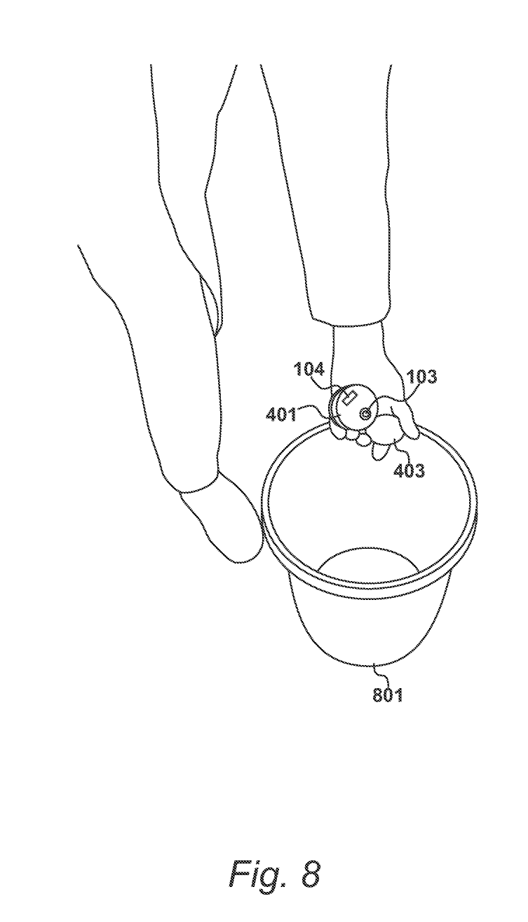

### FIG. 4

The primary portion of the tag identified in FIG. 3 is shown in FIG. 4 in cross-section; cooperating with a secondary portion so as to secure the tag to article 102. The primary potion 401 has a locking mechanism 301 for locking a locking part 402 of a secondary portion 403 of the security tag, so as to secure the security tag to an article, such as article 102.

The primary portion 401 incudes a metal portion in the form of a metal wire 404, configured to perform a contraction when energised, so as to effect a release of the locking mechanism 301 as a result of this contraction. In an embodiment, the metal wire is a shape-memory-alloy wire.

In an embodiment, the shape-memory-alloy wire is resistance heated when energised which, in this embodiment, requires the wire to be heated to a temperature of seventy degree Celsius for approximately 0.2 seconds. In an embodiment, the energy for achieving this degree of heating is supplied by a super capacitor which, in this example, has a capacitance of 3.3 farads.

The combination of a voltage regulator and an amplifier maintains an applied electro motive force of 5 volts on the wire. The wire typically has a resistance of 3.1 ohms, resulting in a heating current of approximately 1.6 amps.

The locking mechanism includes a spring 405 and the release is effected by compressing this spring in response to a contraction of the shape-memory-alloy wire 404.

In the embodiment of FIG. 4, the locking part, in the form of pin 402, extends from the secondary portion 403 and into the primary portion 401 by the application of an appropriate tool in the direction of arrow 406.

The secondary portion 403 includes a spring 407 that is usually in compression and thereby applies force to pin 402. In this way, the locking part undergoes a retraction when a release is effected. Thus, in an embodiment, the shape-memory-alloy wire 404 is energised for an interval that is long enough to allow the locking part 402 to undergo this retraction. Thus, after the spring 407 has caused the pin 402 to retract, the shape-memory-alloy wire 404 cools down, resulting in the expansion of spring 405; such that the locking mechanism is returned to a condition suitable for receiving a locking part again, without requiring further mechanical intervention.

### FIG. 5

A diagrammatic representation of the primary portion identified in FIG. 3 is detailed in FIG. 5. Processor 303 may be a Texas Instruments TRF7970A and facilitates wireless communication via an antenna 501. To facilitate operation within conventional security environments, the primary portion is also provided with an RFID (Radio Frequency Identification Device) 502. This also provides the primary portion with a unique identification and this identification may be read by processor 303. Processor 303 also communicates with a near-field communication (NFC) device 503. Other known types of security technology could be used, such as the technology known as electronic article surveillance.

A charging socket 504 allows charge to be supplied to the power supply unit 306 via a voltage regulation circuit 505. Similarly, output current from the power supply unit 306 is controlled by an output voltage regulator 506, before being supplied to the processor 303 and a power amplifier 507.

In an embodiment, the power supply unit 306 includes a rechargeable lithium battery 508 and circuits 505 and 506 are responsible for controlling the charging and discharging of the lithium battery 508, so as to maintain the integrity of the battery. The battery 508 is responsible for maintaining power to the processor 303 but batteries of this type are not suitable for supplying relatively large currents, as required for the removal of the article upon authorisation.

In addition to battery 608, the power supply unit 306 also includes a capacitor 509 having a capacitance of several farads and being of a construction generally referred to as a super capacitor or electric—layer capacitor. Initially, the capacitor 509 receives charge via the input socket 504 and the regulator 505. Regulator 506, under the control of the processor 303, is then responsible for providing power to the power amplifier 507 during tag removal.

It is also appreciated that, over time, the capacitor 509 may lose charge, therefore charge is maintained on the capacitor 509 by receiving a trickle charge from the battery 508. In an alternative embodiment, the capacitor could be allowed to fully discharge and is then charged, over a period of seconds, when the internal processor is interrupted from its low power consumption state.

Thus, in this configuration, the capacitor 509 is responsible for delivering high current levels when a release is required, whereas the battery 508 is responsible for maintaining power to the processor 303 when the processor is in a low power consumption state.

### FIG. 6

Operations performed by the internal processor 303 are illustrated in FIG. 7. In an embodiment, the processor 303 is an RFID and NFC transceiver integrated circuit, although other implementations are possible.

Step 601 identifies a non-deployed mode, that is followed by step 602 where the primary portion receives charge via socket 504. In an embodiment, each device is hardcoded with a unique code and this code may be derived from RFID device 502. Alternatively, it is possible for the device to receive a code when being charged at step 602.

After receiving charge at step 62, deployment occurs which, in an embodiment, results in the primary portion receiving a locking part in the form of a pin. This operation may activate devices which in turn inform an administration system to the effect that the primary portion is now in use at step 603. At step 604, the processor enters a passive mode, during which it is configured to achieve minimal power consumption, so as to remain operational for as long as possible without requiring additional charging.

An active mode starts at step 605 in response to receiving the input signal instructing the internal processor to initiate a release procedure. At step 606, the internal processor transmits data and opens a data-receive window at step 607, during which it is responsive to receiving the input signal from the administration system.

In an embodiment, if an input signal is not received from the administration system within this window, a time-out occurs and the internal processor returns to its minimal power consumption state.

In this embodiment, a question is asked at step 608 as to whether the window is to close. If this is answered in the negative, a question is asked at step 609 as to whether a valid input signal has been received. If answered in the negative, the process repeats until the question asked at step 608 is answered in the affirmative, whereupon the processor returns to its low power consumption mode at step 604.

If a valid input signal is received, the question asked at step 609 is answered in the affirmative and the release mechanism is energised at step 610. Thereafter, a close down process occurs at step 611, returning the processor to its non-deployed mode at step 601.

### FIG. 7

In an embodiment, the administration system is implemented on hardware supporting a web application and communications systems for effecting wireless communication to the tags in order to transmit input signals. The web application also includes access to a web sales site, as is well known in the art.

A protocol diagram, representing communications performed within the environment illustrated in FIG. 1, is shown in FIG. 7. The protocol it depicts provides for the location of a security tag upon an article and removal from the article upon authorisation. The security tag has an internal processor and a release mechanism and the internal processor is arranged to receive an input signal indicating an authorisation to remove.

The internal processor is configured to facilitate a removal upon receiving the input signal. However, the internal processor will only allow a removal to be made upon also detecting a manual operation performed by the user.

Prior to receiving an input signal indicating an authorisation to remove, the tag receives an instruction from the physical switching means shown at 701, in response to a manual activation made on the part of the user. This represents the first manual operation, indicating the user's interest, and a further manual operation will be required in order to effect final removal.

At 702, the tag responds by making contact with mobile device 201. In accordance with an aspect of the present invention, the mobile device 201 interacts directly with the administration system as shown at 703. The mobile device has received information from the tag at 702, providing a unique identification. This unique tag identification, along with an identification of the mobile device, are conveyed together at 703. The administration system now has information identifying the user who wishes to purchase the article and details of the article that they wish to purchase.

As illustrated at 704, data is returned from the administration system to the mobile device to facilitate the purchasing exercise. This interaction may take the form of transmitting HTML encoded pages that are decoded within a browser application running on the mobile device. Thus, as shown at 705, visual information is supplied to the user from the mobile device and at 706 the mobile device receives user input. Input data from the user is then transmitted from the mobile device to the administration system at 707.

In embodiments, interactions 704 to 707 may be repeated a plurality of times until the sale has been concluded.

After completing the transaction, the input signal is transmitted to the tag from the administration system, as indicated at 708. Thus, in accordance with an aspect of the invention, the internal processor receives an input signal indicating an authorisation to remove. At this point, it would be possible for the tag to disengage automatically. However, it has been appreciated that an automatic disengagement of this type can create problems therefore, in accordance with an aspect of the present invention, the disengagement is made under user control. Thus, according to this aspect of the invention, the tag indicates to the user that the tag is ready for removal by activating a visual display, such as display device 104, as illustrated at 709. The user is then required to perform a further manual operation 710. In an embodiment, this may involve a further activation of button 103.

### FIG. 8

It has been recognised that it is preferable, when in use, for disengaged tags to be collected, to ensure that they are not lost and can be returned for redeployment. In an embodiment, significant advantages are gained from reducing the requirement for sales assistants to locate items, facilitate fitting and interact during the sale of the item. Much of this advantage is lost if tags become lost or damaged. Thus, procedures are adopted that nudge users towards disengaging tags such that they can be collected in a receptacle, such as receptacle 801 shown in FIG. 8.

Thus, having completed the transaction and seeing visual display device 104 being activated again, a user is encouraged to activate button 103 again while the tag is held over the receptacle 801. Furthermore, by controlling the deactivation of the tag, the user has control over the component parts and is less likely to misplace one of the parts after deactivation.

It is also appreciated that visual output displays other than those present to the tag itself could indicate to a user that a disengagement is now possible. Furthermore, in alternative embodiments, it is possible that disengagement may only occur within fixed specified geographical regions, such as a region where the tag is held over a receptacle, as shown in FIG. 8 Thus, in this embodiment, disengagement will only occur when a receptacle is available to receive the component parts.

What we claim is:

1. A security tag for location upon an article and removal from said article upon authorisation, comprising:
an internal processor arranged to transmit an output signal to an external processor indicating that a customer has identified an interest in the article; and
physical switching means, wherein an activation of said physical switching means initiates a procedure for said internal processor to transmit said output signal.

2. The security tag of claim 1 having a housing, wherein said physical switching means extends from said housing.

3. The security tag of claim 1, wherein said physical switching means is a manually operable switch.

4. The security tag of claim 1, wherein said procedures are initiated by interrupting said internal processor out of a minimal power consumption state.

5. The security tag of claim 1, including a visual indicator, wherein said visual indicator is activated in response to an initiation of said procedure.

6. The security tag of claim 5, wherein after authorisation the tag is removed after further manual operation.

7. The security tag of claim 6, wherein said visual indicator is activated in response to an authorisation so as to invite said further manual operation.

8. A security tag for location upon an article and removal from said article upon authorisation, comprising:
a transmitter for transmitting an output signal to a mobile device; and
a receiver for receiving an input signal from an administration system indicating that the tag can be released, wherein:
said mobile device interacts with said administration system directly to effect a purchase of the item prior to the administration system issuing said input signal.

9. The security tag of claim 8, wherein said transmitter is activated after the tag has experienced an interaction with a user.

10. The security tag of claim 9, wherein a first visual indication is presented to said user in response to said interaction.

11. The security tag of claim 8, wherein said output signal represents a unique tag identification.

12. The security tag of claim 11, wherein said interaction includes sending said unique tag identification and a mobile identification to the administration system.

13. The security tag of claim 8, wherein said tag provides a second visual indication when said input signal has been received.

14. The security tag of claim 8, wherein the tag is released only after experiencing a further physical action performed by a user.

15. A security tag for location upon an article and removal from said article upon authorisation, comprising
an internal processor and
a release mechanism, wherein:
said internal processor is arranged to receive an input signal indicating an authorisation to remove; and
said internal processor is configured to facilitate a removal upon receiving said input signal and upon detecting a manual operation performed by the user.

16. The security tag of claim 15, including visual indication means, wherein
said visual indication means indicates that the tag has been authorised for removal after receiving said input signal, such that said indication invites a user to perform said manual operation.

17. The security tag of claim 15, wherein said release mechanism includes a shape memory alloy configured to facilitate a removal when heated.

18. The security tag of claim 17, wherein said shaped memory alloy is heated in response to receiving an electric current from a capacitor.

19. The security tag of claim 15, wherein:
physical removal of the tag operates a second switching means configured to activate an alarm; and
said activation is inhibited after said input signal has been received.

20. The security tag of claim 15, wherein said manual operation is an activation of a manually operable switching means.
